(19) United States
(12) Patent Application Publication
(10) Pub. No.: US 2017/0210458 A1
(43) Pub. Date: Jul. 27, 2017

(54) AIRCRAFT FRAME STRUCTURE AND ASSOCIATED METHOD

(71) Applicant: Airbus Operations Limited, Bristol (GB)

(72) Inventors: Guy TOTHILL, Bristol (GB); Laid ADDA, Bristol (GB); Anthony LANGLEY, Bristol (GB)

(73) Assignee: Airbus Operations Limited, Bristol (GB)

(21) Appl. No.: 15/328,284

(22) PCT Filed: Jul. 17, 2015
(86) PCT No.: PCT/GB2015/052074

§ 371 Date: Jan. 23, 2017

(30) Foreign Application Priority Data
Jul. 23, 2014 (GB) 1413088.4

(51) Int. Cl. B64C 1/12; B32B 7/04; B32B 43/00; B64C 1/08; B64C 3/26

(52) U.S. Cl. CPC B64C 1/12; B64C 1/08; B64C 3/26; B32B 43/00; B32B 7/045; B64C 2001/0072

(57) ABSTRACT

An aircraft frame structure including a grid support (such as a geodetic support) (2) and (i) an impact-resistant barrier (6) including a shear thickening fluid, and (ii) a water-resistant, elastically-deformable cover (4). Methods to make and repair an aircraft using the aircraft frame structure.

### BACKGROUND OF THE INVENTION

The present disclosure relates to an aircraft frame structure, and more specifically to an aircraft frame structure comprising a grid support, such as a geodetic support.

The present invention concerns an aircraft frame structure. More particularly, but not exclusively, this invention concerns an aircraft frame structure comprising grid support, such as a geodetic support. The invention also concerns a method of making an aircraft frame structure, a laminate for making an aircraft frame structure, a method of repairing or maintaining an aircraft, an aircraft component and an aircraft.

Conventional modern aircraft structures typically comprise a “skin” of aluminium alloy supported by frames, stringers, spars, webs and the like. Such structures can be heavy and may be complex to manufacture (for example, in the case of some supporting elements made from composite materials). Furthermore, such conventional structures sometimes require the use of many bolts or rivets to connect components together. The use of many bolts may lead to an increase in construction time and may provide many points at which lightning may strike an aircraft.

The present invention seeks to mitigate one or more of the above-mentioned problems. Alternatively or additionally, the present invention seeks to provide an improved aircraft frame structure.

### SUMMARY OF THE INVENTION

The present invention provides, according to a first aspect, an aircraft frame structure comprising a grid support and an impact-resistant barrier comprising a shear thickening material.

The grid support is essentially a support in the form of grid, such as a geodetic support.

Shear thickening materials (such as shear thickening fluids) provide impact-resistant structures which are potentially light and which may resist impacts associated with civil aircraft, such as bird strikes or being struck by airport service vehicles.

The shear thickening material may comprise a shear thickening fluid. The impact-resistant barrier is typically in the form of a sheet. The impact-resistant barrier typically extends across the part of the grid support which would otherwise be exposed to impact risks external to the aircraft.

The aircraft frame structure may comprise a water-resistant cover. “Water-resistant” indicates that the cover is not substantially degraded by exposure to water. The water-resistant cover may optionally be water-repellent. The water-resistant cover may also be resistant to one of more of: exposure to ultraviolet radiation, phosphate esters, aviation fuel, methyl ethyl ketone, isopropyl alcohol and aircraft de-icing fluid (typically comprising a glycol, such as ethylene or propylene glycol). The water-resistant cover is typically in the form of a sheet. The cover typically covers the part of the impact-resistant barrier which would otherwise be exposed to ambient conditions external to the aircraft. The cover is typically located external to the impact-resistant barrier, and it typically the outermost part of the aircraft frame structure, although one may apply paint or other coatings to the cover, if desired. The water-resistant cover optionally comprises a coated or impregnated fabric. The water-resistant cover is optionally elastically deformable. The aircraft frame structure optionally comprises an attachment means between the impact-resistant barrier and the grid support. The attachment means is typically provided to attach the cover and the impact-resistant barrier. Typically, the attachment means and the cover are attached together, thereby attaching interposing sheets (such as the impact-resistant barrier). The attachment means may optionally comprise a sheet, for example, a sheet of thermoplastic material, such as a thermoplastic polymer. The impact-resistant barrier may, for example, comprise a polymer, and may comprise fibres. For example, the impact-resistant barrier may comprise an aramid (an aromatic polyamide). Kevlar® is an example of such an aramid. The impact-resistant barrier may comprise a shear thickening material (such as a shear thickening fluid) and a material-supporting substrate, such as a textile comprising an aramid.

According to a second aspect of the invention, there is also provided an aircraft frame structure comprising a grid support and a water-resistant, elastically deformable cover.

The grid support is essentially a support in the form of grid, such as a geodetic support.

Such a structure provides a lightweight frame structure for an aircraft, and is particularly effective for aircraft frame structures which are subject to aerodynamic forces, but not subject to pressurisation forces (forces generated by pressurisation of one or more cavities of the aircraft, such as a passenger cabin). “Water-resistant” indicates that the cover is not substantially degraded by exposure to water. The water-resistant cover is optionally water-repellent.

The water-resistant cover may also be resistant to one of more of: exposure to ultraviolet radiation, phosphate esters, aviation fuel, methyl ethyl ketone, isopropyl alcohol and aircraft de-icing fluid (typically comprising a glycol, such as ethylene or propylene glycol). The cover is typically in the form of a sheet. The aircraft frame structure may comprise an impact-resistant barrier. The impact-resistant barrier is typically situated between the water-resistant, elastically deformable cover and the grid support. The impact-resistant barrier is typically in the form of a sheet. An attachment means may be provided between the impact-resistant barrier and the grid support. The attachment means may optionally comprise a sheet, for example, a sheet of thermoplastic material, such as a thermoplastic polymer. The impact-resistant barrier may, for example, comprise a polymer, and may comprise fibres. For example, the impact-resistant barrier may comprise an aramid (an aromatic polyamide). Kevlar® is an example of such an aramid. The impact-resistant barrier may, for example, comprise a shear thickening material, such as a shear thickening fluid. The impact-resistant barrier may comprise a shear thickening material (such as a shear thickening fluid) and a material-supporting substrate.

For the avoidance of doubt, the statements below relate to the aircraft frame structure of both the first and second aspects of the present invention.

The water-resistant elastically deformable cover may comprise a coated or impregnated fabric. For example, the water-resistant elastically deformable cover may comprise a fabric (such as elastane, for example, Lycra®) provided with a water-resistant coating (such as polyurethane).

The water-resistant elastically deformable cover may comprise a thermoplastic. This is of particular benefit if a thermoplastic attachment means is provided, since the attachment means and the cover may be heated to provide a join between the cover and the attachment means, thereby securing any interposed structures, such as the impact-resistant barrier.

If the impact-resistant barrier comprises a shear thickening material and a material-supporting substrate, then the material-supporting substrate may comprise a gel, a fabric or a foam, for example. The material-supporting substrate may provide additional impact protection, for example, if the material-supporting substrate comprises a fabric, such as an aramid fabric. The shear thickening material may comprise a silicone, for example, or a polyborondimethyl siloxane (such as that described in US20050037189), or silicon particles in a solution of poly(ethylene glycol).

The impact-resistant barrier may comprise a layered structure, and may optionally comprise a plurality of layers of material-supporting substrate and shear thickening material (in particular, shear thickening fluid).

The aircraft frame structure may comprise a thermal insulator. The thermal insulator is optionally in the form of a sheet. The thermal insulator is optionally located inwards of the impact-resistant barrier. The thermal insulator is optionally located external to an attachment means, if an attachment means is provided.

The aircraft frame structure may comprise a lightning strike dissipater. The lightning strike dissipater is electrically conductive (and is therefore typically metallic) and is optionally in the form of a sheet. The lightning strike dissipater optionally comprises a mesh or a grid. Such arrangements help reduce weight. The lightning strike dissipater optionally comprises ferrogel or ferrofluids. The lightning strike dissipater is optionally located internally of the water-resistant cover and optionally externally of the impact-resistant barrier. Lightning strike dissipation may be provided by providing conductive particles. Such particles may be incorporated into one or more components of the aircraft frame structure.

The term “geodetic” will be well-known to those skilled in the art of aircraft construction. “Geodetic” indicates that the support comprises a plurality of structural members connected to form a frame in which the structural members follow a curved surface. In this way, the frame forms the aerodynamic shape of the aircraft. The structural members are usually (but not always) straight and are arranged to form a network or grid comprising multiple load paths.

The shape and structure of the grid support will depend on the aircraft frame structure's intended use. For example, if regions of the aircraft frame structure are more curved (i.e. lower radius of curvature), then a greater number of supports will be used in those regions of lower radius of curvature. The grid support (particularly a geodetic support) may comprise a plurality of connected beams, for example, hollow beams or channel beams. The grid structure may be formed from an alloy, such as an aluminium alloy. Furthermore, the number of support members used may be determined by the stiffness of the overlying structure; a relatively stiff overlying structure may not undergo significant drag-inducing deformation under aerodynamic loading and so fewer supports may be required. A relatively flexible overlying structure may require a higher density of supports to prevent significant drag-inducing deformation of the overlying structure during aerodynamic loading.

The aircraft frame structure may comprise a laminate comprising the water-resistant cover and the impact-resistant barrier. The laminate may comprise the attachment means, and may optionally comprise the thermal insulator and/or lightning strike dissipater. The laminate may comprise the lightning strike dissipater located between the water-resistant cover and the impact-resistant barrier. The laminate optionally comprises the impact-resistant barrier (and optionally one or both of the thermal insulator and the lightning strike dissipater) interposed between the water-resistant cover and the attachment means. For the avoidance of doubt, the water-resistant cover, the impact-resistant barrier, the thermal insulator (if present), lightning strike dissipater (if present) and attachment means (if present) are typically provided as sheets. “Laminate” indicates that the various component parts of the laminate are attached together. However, the laminate does not have to be attached across the entire area of the various components. Indeed, it is expected that the laminate will be attached at a plurality of discrete points (for example, by spot welding).

A third aspect of the present invention provides a method of making an aircraft frame structure, the method comprising:

(a) providing a grid support and a laminate comprising an impact-resistant barrier comprising a shear thickening material and a water-resistant elastically deformable cover; and
(b) attaching the laminate to the grid support.

The grid support is a support in the form of a grid. The grid support may comprise a geodetic support.

The laminate may comprise an attachment means for attaching the laminate together. The attachment means may comprise a thermoplastic material, such as a thermoplastic polymer. The attachment means may comprise a sheet of thermoplastic material. The shear thickening material may typically comprise a shear thickening fluid. “Water-resistant” has substantially the same meaning as it does in relation to the first and second aspects of the present invention. The water-resistant cover may be water-repellent.

The laminate may comprise those features described above in relation to the aircraft frame structure of the first and/or second aspects of the present invention.

The method may comprise forming said laminate. This may, for example, comprise forming a layered structure comprising the impact-resistant barrier, the water-resistant elastically deformable cover and the attachment means, thermal insulator and lightning strike dissipater (if present) and attaching the layers together to form the laminate. The impact-resistant barrier, the water-resistant elastically deformable cover and the attachment means, thermal insulator and lightning strike dissipater (if present) are typically provided as sheets. This attachment may, for example, comprise forming a plurality of spaced attachments. For example, if the attachment means comprises a thermoplastic and the water-resistant elastically deformable cover comprises a thermoplastic, then it may be possible to weld those two components together (and therefore attach the other interposed components) by using spot welding, for example, ultrasonic or induction spot welding.

The features described above in relation to the method of the third aspect of the present invention may comprise those features described above in relation to the aircraft frame structures of the first and second aspects of the present invention.

A fourth aspect of the present invention provides a laminate for use in the method of the third aspect of the present invention. The laminate of the fourth aspect of the present invention may comprise those features described above in relation to the method of the third aspect of the present invention and in relation to the aircraft frame structure of the first and/or second aspects of the present invention.

A fifth aspect of the present invention provides a method of repairing or maintaining an aircraft, the method comprising:

(a) providing an aircraft in need of repair or maintenance;
(b) repairing or maintaining the aircraft using a laminate in accordance with the fourth aspect of the present invention.

The method may comprise providing a support for the laminate. The laminate should be sufficiently flexible to conform to the contours of the grid support.

The support may be a grid support (i.e. a support in the form of a grid). The grid support may comprise a geodetic support. The support may comprise those features described above in relation to the aircraft frame structures in accordance with the first and/or second aspects of the present invention. The method may comprise attaching the laminate to the support and subsequently attaching the support to the aircraft. Alternatively, the method may comprise attaching the support to the aircraft and subsequently attaching the laminate to the support.

A sixth aspect of the present invention provides an aircraft comprising an aircraft frame structure in accordance with the first and/or second aspects of the present invention.

A seventh aspect of the present invention provides an aircraft component comprising an aircraft frame structure in accordance with the first and/or second aspects of the present invention. For example, the aircraft component may be a component which is not subject to loading from pressurisation of a compartment of the aircraft. The aircraft component may, for example, comprise a fairing, such as a belly fairing. The aircraft component may, for example, comprise a landing gear door (such as a nose wheel landing gear door or a main landing gear door), a vertical stabiliser, a horizontal stabiliser, a wing, a spoiler, an aft fuselage (in particular the part of an after fuselage which is aft of the aft bulkhead) or a radome. Certain aircraft components, such as those which are movable relative to other aircraft components (e.g. a door or a spoiler) may be provided with further support to provide rigidity and/or strength.

It will of course be appreciated that features described in relation to one aspect of the present invention may be incorporated into other aspects of the present invention.

Embodiments of the present invention will now be described by way of example only with reference to the accompanying schematic drawings of which:

### DESCRIPTION OF THE DRAWINGS

FIG. 1 shows a perspective view of an aircraft belly fairing comprising an aircraft frame structure according to a first embodiment of the invention;

FIG. 2 shows an exploded view of the aircraft frame structure used in the belly fairing of FIG. 1;

FIG. 3 shows a perspective view from below of an aircraft comprising several aircraft components which comprise an aircraft frame structure according to an embodiment of the invention; and

FIG. 4 shows a plan view from above of the aircraft of FIG. 3.

### DETAILED DESCRIPTION

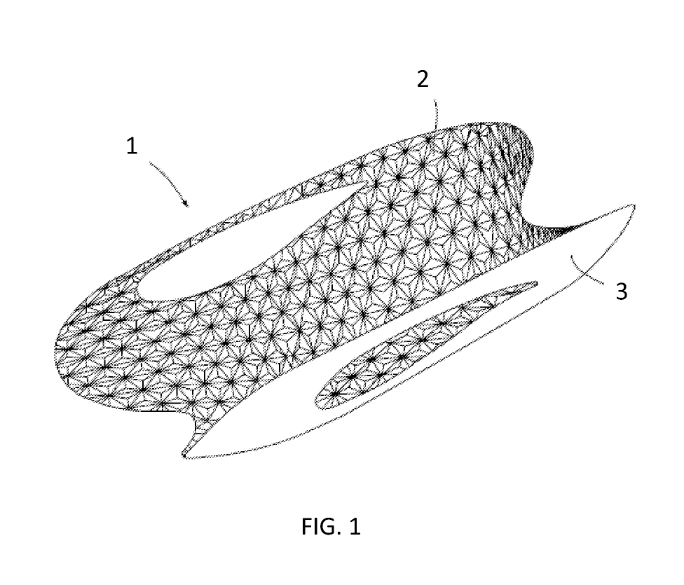

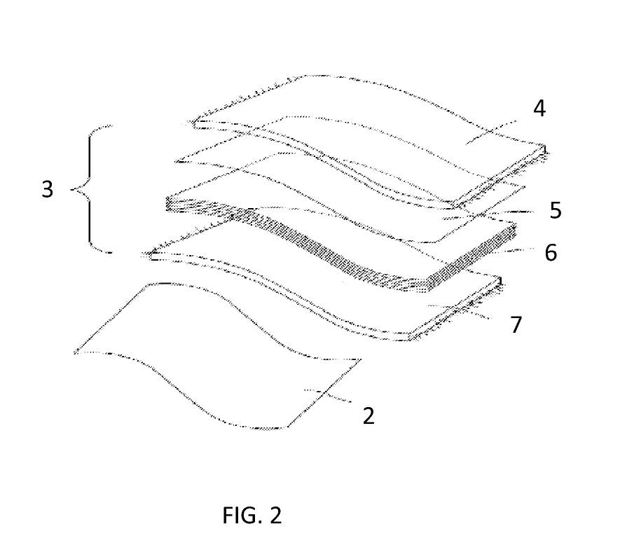

A belly fairing comprising an aircraft frame structure according to an example of an embodiment of the invention will now be described with reference to FIGS. 1 and 2. The belly fairing is denoted generally be reference numeral 1, and comprises a grid support 2 in the form of a geodetic support and an overlying laminate 3. In use, the laminate 3 is located on the outside of the aircraft. The grid support 2 may be made in any suitable manner as will be known to those skilled in the art of airframe construction, such geodetic supports being used in the airframes of the Vickers-Armstrong Wellesley, Wellington, Windsor and Warwick aircraft of the 1930s and 1940s, and as described in “Geodetic Aircraft Structure” by K. D. Powell, Sports Aviation, 1961, pages 17-24. For example, the geodetic support 2 may be formed from a network of aluminium alloy channel-beams, as was used for the Vickers-Armstrong Warwick aircraft. The grid support 2 is lightweight and strong, and if there is local damage to a part of the grid support, the structural integrity of the grid support remote from the damaged area may not be compromised.

The laminate 3 provides weather-resistant covering, lightning strike dissipation protection and impact resistance, as will now be described with reference to FIG. 2. The laminate 3 comprises several sheets, these being (from the outside) a weather-resistant cover 4, a lightning strike dissipater 5, an impact-resistant barrier 6 and an attachment means 7. Each of these sheets will now be described. The weather-resistant cover 4 comprises a sheet of polyurethane-coated elastane (elastane often being known as Lycra®). This material provides an inexpensive lightweight and water-resistant outer cover. The material is elastically-deformable and therefore can be easily fitted and applied to underlying layers. This material should also be resistant to exposure to ultraviolet light, hydraulic fluid, aviation fuel, methyl ethyl ketone and aircraft de-icer. The lightning strike dissipater 5 comprises a sheet of copper foil mesh (for example, MicroGrid® available from Dexmet Applications, CT, USA). Such expanded metal sheets are lightweight and flexible. Those skilled in the art will realise that conductive materials other than copper may be used, for example, aluminium. The impact-resistant barrier 6 comprises several sheets of aramid (in this case, Kevlar®) fabric impregnated with a shear thickening fluid. The impregnation of aramid fabric with various shear thickening fluids is described in US2004/103231 and WO2013/072669. The attachment means 7 comprises a further sheet of polyurethane-coated elastane, identical to the cover 4. The construction of the laminate 3 will now be described.

The laminate 3 is typically made by placing the various sheets of material together and spot welding the two outermost thermoplastic sheets (weather-resistant cover 4 and attachment means 7) at multiple positions. The outermost sheets are welded together, thereby attaching together the interposed sheets (in this case, the impact-resistant barrier and the lightning dissipater), forming a laminate, typically using ultrasonic welding. Ultrasonic welding of thermoplastics may be performed using, for example, hand held welders (such as those supplied by Sonics & Materials Inc., Newtown, Conn., USA or FFR Ultrasonics, Sileby, Leicestershire, UK). The location and spacing of the welds used will depend to some degree on the shape of the aircraft frame structure.

The attachment of the laminate 3 to be grid support 2 will now be described. The laminate 3 is sufficiently flexible to conform to the shape of the grid support 2. The laminate 3 is then attached to the support in any suitable manner. In this case, the thermoplastic attachment means 7 is heated to melt the attachment means so that it adheres to the underlying grid support 2. Mechanical fasteners (in this case, bolts) are also used. It is anticipated the aircraft frame structure will present require fewer bolts and the like than conventional aircraft frame structures, and therefore may present fewer protruding metallic points on the outer surface of the aircraft and therefore decrease the likelihood of a lightning strike occurring.

Alternative methods may be used instead of ultrasonic welding. For example, induction welding may be used, such as is used to weld the rudder and elevators of the Gulfstream® G650. Other methods may, of course, be used, such as methods which cause local heating of the thermoplastics.

The laminate 3 mentioned above may be used to repair or maintain an aircraft. For example, the laminate 3 may be provided onto an existing aircraft frame structure. In repairing or maintaining an aircraft, the laminate may be provided onto an aircraft frame support (such as a grid support, such as a geodetic support), which may then be attached to the aircraft. Alternatively, in repairing or maintaining an aircraft, the aircraft frame support, such as a geodetic support may be attached to the aircraft before the laminate is attached to the aircraft frame support. The laminate may be attached to adjacent fabric material, for example, by stitching.

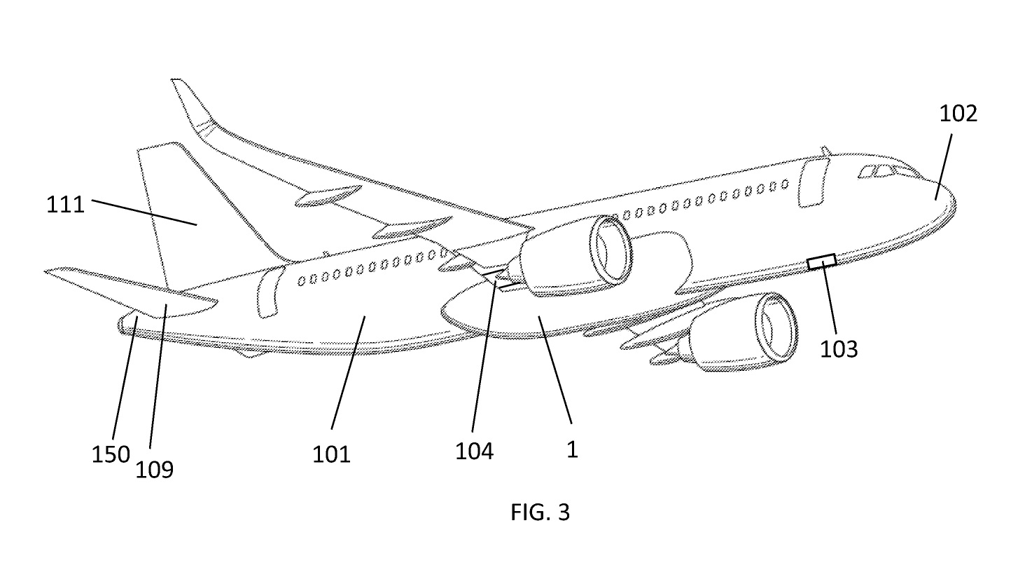

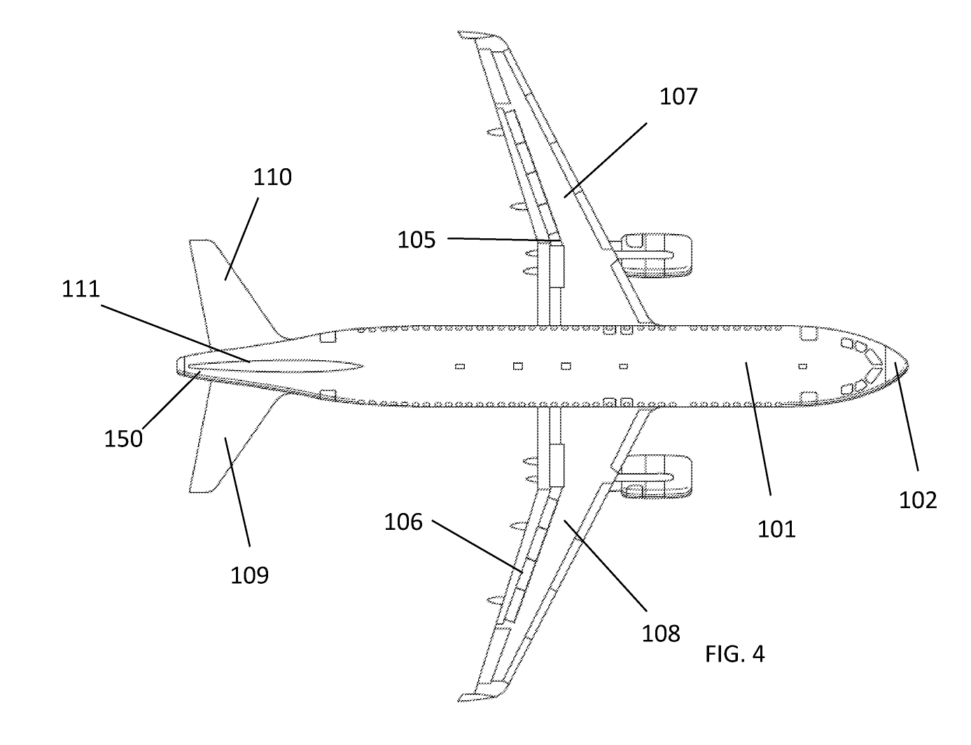

The belly fairing 1 is shown in position on an aircraft 101 in FIG. 3. Examples of other aircraft components comprising an aircraft frame structure in accordance with an embodiment of the invention will now be described with reference to FIGS. 3 and 4. The aircraft 101 comprises a radome 102 located at the nose of the aircraft, the radome 102 comprising a geodetic support and a laminate substantially the same as that described above in relation to the belly fairing 1. The geodetic support defines the shape of the radome and the laminate provides a covering. The aircraft 101 further comprises nose landing gear door 103 and main landing gear doors, one of which 104 is shown in FIG. 3. Each of the landing gear doors 103, 104 comprises a geodetic support which defines the shape of the door and a covering comprising a laminate substantially the same as that disclosed above in relation to the belly fairing 1. The aircraft 101 further comprises spoilers 105, 106 (visible in FIG. 4), each of which comprises a geodetic support which defines the shape of the spoiler and a covering comprising a laminate substantially the same as that disclosed above in relation to the belly fairing 1. The aircraft 101 further comprises wings 107, 108 (visible in FIG. 4), each of which comprises a geodetic support which defines the shape of the wing and provides support for the covering which comprises a laminate substantially the same as that disclosed above in relation to the belly fairing 1. The aircraft 101 further comprises horizontal stabilisers 109, 110 and a vertical stabiliser, each of which comprises a geodetic support which defines the shape of the respective stabiliser and which provides support for a covering which comprises a laminate substantially the same as that disclosed above in relation to the belly fairing 1. The aircraft 101 further comprises an aft fuselage 150, the portion being aft of the aft bulkhead comprising a geodetic support which defines the shape of the fuselage and provides support for the covering which comprises a laminate substantially the same as that disclosed above in relation to the belly fairing 1.

Whilst the present invention has been described and illustrated with reference to particular embodiments, it will be appreciated by those of ordinary skill in the art that the invention lends itself to many different variations not specifically illustrated herein. By way of example only, certain possible variations will now be described.

The example above illustrates the use of a thermoplastic to attach the laminate to the grid support. Other means for attaching the sheet to the support may be used, such as adhesives, for example. Such adhesives are typically initially liquid, but harden subsequently (for example, over time, or when heated or exposed to radiation of a certain wavelength).

Materials other than polyurethane coated Lycra® may be used as the cover.

The example above demonstrates the use of a lightning strike dissipation sheet, in the form of a sheet of expanded copper foil. Alternative lightning strike dissipation sheets may be used (for example, comprising ferrofluids and ferrogels). Alternatively, the lightning strike dissipation sheet may be omitted.

For the aircraft frame structure of the first aspect of the present invention, those skilled in the art will recognise that the presence of a water-resistant elastically deformable cover is not necessary. Likewise, for the aircraft frame structure of the second aspect of the present invention, those skilled in the art will realise that the presence of an impact-resistant barrier is not essential.

Where in the foregoing description, integers or elements are mentioned which have known, obvious or foreseeable equivalents, then such equivalents are herein incorporated as if individually set forth. Reference should be made to the claims for determining the true scope of the present invention, which should be construed so as to encompass any such equivalents. It will also be appreciated by the reader that integers or features of the invention that are described as preferable, advantageous, convenient or the like are optional and do not limit the scope of the independent claims. Moreover, it is to be understood that such optional integers or features, whilst of possible benefit in some embodiments of the invention, may not be desirable, and may therefore be absent, in other embodiments.

1. An aircraft frame structure comprising:
a grid support, and
an impact-resistant barrier comprising a shear thickening material.

2. The aircraft frame structure according to claim 1, wherein the shear thickening material comprises a shear thickening fluid.

3. The aircraft frame structure according to claim 1, wherein the impact-resistant barrier is in the form of a sheet.

4. The aircraft frame structure according to claim 1, further comprising a water-resistant cover.

5. (canceled)

6. An aircraft frame structure comprising:
a grid support, and
a water-resistant, elastically-deformable cover.

7. The aircraft frame structure according to claim 6, wherein the cover is in the form of a sheet.

8. The aircraft frame structure according to claim 6 further comprising an impact-resistant barrier.

9. The aircraft frame structure according to claim 8, wherein the impact-resistant barrier is located between the water-resistant, elastically-deformable cover and the grid support.

10. The aircraft frame structure according to claim 9, wherein the impact-resistant barrier comprises a shear thickening fluid.

11. The aircraft frame structure according to claim 1, wherein the impact-resistant barrier comprises a shear thickening fluid and a fluid-supporting substrate.

12. The aircraft frame structure according to claim 11, further comprising a plurality of layers of the fluid-supporting substrate and the shear thickening fluid.

13. The aircraft frame structure according to claim 4, further comprising an attachment sheet between the impact-resistant barrier and the grid support, the attachment sheet being provided to attach the cover and the impact-resistant barrier.

14. (canceled)

15. The aircraft frame structure according to claim 1 wherein the grid support comprises a geodetic support.

16.-17. (canceled)

18. The aircraft frame structure according to claim 1, further comprising a laminate comprising a sheet of water-resistant cover and a sheet of impact-resistant barrier including a shear thickening fluid.

19. The aircraft frame structure according to claim 18, wherein the laminate comprises an attachment sheet.

20. (canceled)

21. A method of making an aircraft frame structure, the method comprising:
providing a grid support and a laminate comprising an impact-resistant barrier comprising a shear thickening material and a water-resistant elastically deformable cover; and
attaching the laminate to the grid support.

22. A laminate comprising:
a sheet of impact-resistant barrier comprising a shear thickening fluid interposed between a sheet of thermoplastic, a water-resilient elastically-deformable cover and a thermoplastic attachment sheet, and
the water-resilient elastically-deformable cover and the thermoplastic attachment sheet being attached together at a plurality of discrete points.

23. A method of repairing or maintaining an aircraft, the method comprising:
providing an aircraft in need of repair or maintenance;
repairing or maintaining the aircraft using a laminate comprising a sheet of impact-resistant barrier including a shear thickening fluid interposed between a sheet of thermoplastic, a water-resilient elastically-deformable cover and a thermoplastic attachment sheet,
wherein the water-resilient elastically-deformable cover and the thermoplastic attachment sheet are attached together at a plurality of discrete points.

24. An aircraft comprising the aircraft frame structure according to claim 1.

25. An aircraft component comprising an aircraft frame structure according to claim 1, wherein the aircraft component being at least one of: a fairing, a belly fairing, a landing gear door, a nose landing gear door, a main landing gear door, a vertical stabiliser, a horizontal stabiliser, a wing, a spoiler, a radome and an aft fuselage.

26. (canceled)
